(19) United States
(12) Patent Application Publication
(10) Pub. No.: US 2026/0286106 A1
(43) Pub. Date: Sep. 24, 2026

(54) RUBBER COMPOSITIONS AND ARTICLES THEREOF

(71) Applicant: The Goodyear Tire & Rubber Company, Akron, OH (US)

(72) Inventors: Julia Martine Francoise Claudine Tahon, Reckange (LU); Celia Pauline Elodie Mougel, Berg-sur-Moselle (FR); Paul Harry Sandstrom, Cuyahoga Falls, OH (US)

(21) Appl. No.: 19/084,059

(22) Filed: Mar. 19, 2025

(51) Int. Cl. C08L 7/00; B60C 1/00; C08J 3/20; C08K 5/31; C08K 5/40; C08K 5/47; C08L 9/00

(52) U.S. Cl. CPC C08L 7/00; B60C 1/0025; C08J 3/201; C08K 5/31; C08K 5/40; C08K 5/47; C08L 9/00; B60C 2001/005; C08J 2307/00; C08J 2309/00; C08L 2205/025; C08L 2205/035

(57) ABSTRACT

In one aspect, the disclosure relates a composition, comprising an elastomer, comprising from about 25 phr to about 75 phr of a natural rubber and from about 25 phr to about 75 phr of a synthetic elastomer; an accelerator, comprising from about 0.1 phr to about 5 phr of a first accelerator and about 0.1 phr to about 5 phr a second accelerator; and about 0.1 phr to about 10 phr of a hydrogenated gum rosin. The disclosure also relates to articles, such as tires and/or components of tires, comprising the disclosed compositions. Also disclosed herein are methods for mixing rubber. This abstract is intended as a scanning tool for purposes of searching in the particular art and is not intended to be limiting of the present disclosure.

### BACKGROUND

The demand for improved tire performance has resulted in the development and evaluation of new materials that have desirable properties. Improving tire properties such as ozone resistance while maintaining the balance in tradeoffs can be challenging. For example, tires with good ozone resistance, which at least in part can be attributed to wax additives migrating to the surface of a tire sidewall and/or chafer, can also exhibit visible wax blooming on the surface of the tire. Visible blooming on a tire surface can be viewed as a negative for both sellers, purchasers, and/or users of tires. There is a need for rubber formulations that exhibit good properties, such as ozone resistance, while also maintaining visual appeal in the products produced from them. These needs and other needs are satisfied by the present disclosure.

### SUMMARY

In accordance with the purpose(s) of the disclosure, as embodied and broadly described herein, the disclosure, in one aspect, relates to compositions comprising: an elastomer, comprising from about 25 phr to about 75 phr of a natural rubber and from about 25 phr to about 75 phr of a synthetic elastomer; an accelerator, comprising from about 0.1 phr to about 5 phr of a first accelerator and about 0.1 phr to about 5 phr a second accelerator; and about 0.1 phr to about 10 phr of a hydrogenated gum rosin. In one aspect, the hydrogenated gum rosin has an acid value of about 140 mg KOH/g to about 200 mg KOH/g. In another aspect, the hydrogenated gum rosin has a softening point of about 70° C. to about 125° C. Also disclosed herein are articles, such as tires and/or components of tires, comprising the disclosed compositions.

Also disclosed herein is a method for mixing rubber, comprising combining together an elastomer and about 0.1 phr to about 10 phr of a hydrogenated gum rosin, thereby forming an initial mixture; mixing the initial mixture at a temperature of about 130° C. to about 180° C., thereby forming a first stage mixture; combining together the first stage mixture with 0.1 phr to about 5 phr of a first accelerator and about 0.1 phr to about 5 phr a second accelerator, thereby forming an intermediate mixture; and mixing the intermediate mixture at a temperature of about 90° C. to about 110° C., thereby forming a second stage mixture. In one aspect, the elastomer comprises from about 25 phr to about 75 phr of a natural rubber and from about 25 phr to about 75 phr of a synthetic elastomer. In another aspect, the hydrogenated gum rosin has an acid value of about 140 mg KOH/g to about 200 mg KOH/g. In yet another aspect, the hydrogenated gum rosin has a softening point of about 70° C. to about 125° C.

Other systems, methods, features, and advantages of the present disclosure will be or become apparent to one with skill in the art upon examination of the following detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1G show representative pictures of sidewall rubber specimens that have undergone dynamic ozone resistance testing.

FIGS. 2A-2G show representative pictures of sidewall rubber specimens that have undergone static ozone resistance testing.

FIGS. 3A-3B show representative pictures of sidewall rubber specimens that have undergone ozone resistance testing.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the composition statutory class, this is for convenience only and one of skill in the art will understand that each aspect of the present disclosure can be described and claimed in any statutory class.

Although specific terms are employed herein, they are used in a generic and descriptive sense only and not for purposes of limitation. It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “an elastomer,” “an accelerator,” or “a wax,” includes, but is not limited to, two or more such elastomers, accelerators, or waxes, and the like. Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical compound, where the molecules may or may not be identical (e.g., different isotopic ratios, enantiomers, and the like).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

The terms “rubber” and “elastomer” may be used herein interchangeably, unless indicated otherwise.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In one aspect, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In one aspect, rubber compositions can be cured in molds in order to form finished articles such as tires.

As used herein, the term “repeat unit” as referenced in the elastomers described herein are derived from monomers used to produce the partially saturated elastomers. For example, polybutadiene has the repeat unit as provided below.

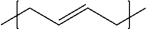

In certain aspects, when the elastomer is the polymerization product of two different monomers (e.g., A and B), the repeat unit can be represented by -A-B—.

As used herein, a “residue” of a chemical species refers to the moiety that is the resulting product of the chemical species in a particular reaction scheme or subsequent formulation or chemical product, regardless of whether the moiety is actually obtained from the chemical species. Thus, an isoprene residue in an elastomer refers to one or more —CH₂CH═C(CH₃)CH₂— units in the elastomer, regardless of whether isoprene was used to prepare the elastomer. Similarly, a butadiene residue in an elastomer refers to one or more-CH₂CH═CHCH₂— moieties in the elastomer, regardless of whether the residue is obtained by reacting sebacic acid or an ester thereof to obtain the polyester.

Unless otherwise specified, temperatures referred to herein are based on atmospheric pressure (i.e. one atmosphere).

### B. Rubber Compositions

In one aspect, the disclosure relates to compositions, such as uncured or cured rubber compositions, comprising an elastomer, an accelerator, and about 0.1 phr to about 10 phr of a hydrogenated gum rosin. In one aspect, the elastomer can comprise from about 25 phr to about 75 phr of a natural rubber and from about 25 phr to about 75 phr of a synthetic elastomer. In one aspect, the accelerator can comprise from about 0.1 phr to about 5 phr of a first accelerator and about 0.1 phr to about 5 phr a second accelerator. In a further aspect, the total amount of accelerators present in the composition can range from about 0.5 phr to about 5 phr, about 0.5 phr to about 4 phr, about 0.5 phr to about 3 phr, about 0.5 phr to about 2 phr, about 1 phr to about 5 phr, about 1 phr to about 4 phr, or about 1 phr to about 3 phr. The compositions disclosed herein exhibit good ozone resistance while also exhibiting reduced visible wax blooming on their surface. The present disclosure also relates to methods of making the disclosed compositions and to articles, such as tires and/or components of tires, comprising the compositions.

In another aspect, the elastomer can comprise from about 25 phr to about 75 phr, about 30 phr to about 75 phr, about 35 phr to about 75 phr, about 40 phr to about 75 phr, about 25 phr to about 70 phr, about 25 phr to about 65 phr, about 25 phr to about 60 phr, about 30 phr to about 70 phr, or about 40 phr to about 60 phr of natural rubber. In another aspect, the elastomer can comprise from about 25 phr to about 75 phr, about 30 phr to about 75 phr, about 35 phr to about 75 phr, about 40 phr to about 75 phr, about 25 phr to about 70 phr, about 25 phr to about 65 phr, about 25 phr to about 60 phr, about 30 phr to about 70 phr, or about 40 phr to about 60 phr of a synthetic elastomer. In one aspect, the total phr of natural rubber and synthetic elastomer present in the composition totals to 100 phr. The synthetic elastomer can comprise repeat units formed from residues of monomers selected from ethylene, propylene, isobutene, butadiene, isoprene, styrene, and acrylonitrile, and a combination thereof. In another aspect, the elastomers can have a number average molecular weight (Mₙ) between 100,000 Da and 500,000 Da. Mn may be determined by methods known in the art, such as by gel permeation chromatography following ASTM D3536 or equivalent.

In another aspect, the composition can comprise from about 0.1 phr to about 10 phr, about 0.1 phr to about 8 phr, about 0.1 phr to about 5 phr, about 0.1 phr to about 3 phr, about 1 phr to about 10 phr, about 3 phr to about 10 phr, about 5 phr to about 10 phr, or about 7 phr to about 10 phr, about 0.5 phr to about 5 phr, or about 0.5 phr to about 3 phr of a hydrogenated gum rosin. Gum rosin is a resinous material that can be extracted from pine trees. Gum rosin is composed of a mixture of organic compounds, including acids such as abietic acid, pimaric acid, and derivatives thereof. Raw gum rosin can be refined or processed to produce various derivatives of gum rosin, such as hydrogenation. An example of a hydrogenated gum rosin is white or water-white gum rosin, which can be produced from raw gum rosin by processes such as hydrogenation, disproportionation, and other treatment methods. Hydrogenated gum rosin can be characterized by a variety of physical properties, including acid value and softening points. The acid value refers to the quantity of a base needed to neutralize acidic groups contained in a sample. In one aspect, the acid value is the mg of KOH required to neutralize the acidic groups contained in one gram of hydrogenated gum rosin. In one aspect, the hydrogenated gum rosin can have an acid value of from about 140 mg KOH/g to about 200 mg KOH/g, about 150 mg KOH/g to about 200 mg KOH/g, about 160 mg KOH/g to about 200 mg KOH/g, about 170 mg KOH/g to about 200 mg KOH/g, about 140 mg KOH/g to about 190 mg KOH/g, about 140 mg KOH/g to about 180 mg KOH/g, about 140 mg KOH/g to about 170 mg KOH/g, about 150 mg KOH/g to about 190 mg KOH/g, or about 160 mg KOH/g to about 180 mg KOH/g. In one aspect, the hydrogenated gum resin can have a softening point of from about 70° C. to about 125° C., about 70° C. to about 115° C., about 70° C. to about 105° C., about 70° C. to about 100° C., about 70° C. to about 90° C., about 80° C. to about 125° C., about 90° C. to about 125° C., about 100° C. to about 125° C., about 80° C. to about 115° C., or about 90° C. to about 105° C. In one aspect, the softening point can be determined following ASTM E28 or an equivalent method.

In another aspect, the accelerator can comprise from about 0.1 phr to about 5 phr, about 0.1 phr to about 4 phr, about 0.1 phr to about 3 phr, or about 0.1 phr to about 2 phr of a first accelerator. The first accelerator can be selected from a dithiocarbamate compound, a thiuram compound, a guanidine compound, and a combination thereof. In a further aspect, the first accelerator can be selected from zinc diethyl dithiocarbamate; zinc N-dibutyl dithiocarbamate; zinc N-ethyl-N-phenyl dithiocarbamate; zinc dibenzyldithiocarbamate; tetrabenzylthiuram disulfide; diphenylguanidine; 1,3-di-o-tolylguanidine; triphenylguanidine; and a combination thereof. In another aspect, the first accelerator can be selected from a thiuram compound, a guanidine compound, and a combination thereof. In a further aspect, the first accelerator can be selected from tetrabenzylthiuram disulfide, diphenylguanidine, 1,3-di-o-tolylguanidine, triphenylguanidine, and a combination thereof. In another further aspect, the first accelerator can be selected from tetrabenzylthiuram disulfide, diphenylguanidine, and a combination thereof.

In another aspect, the accelerator can comprise from about 0.1 phr to about 5 phr, about 0.1 phr to about 4 phr, about 0.1 phr to about 3 phr, about 0.1 phr to about 2 phr, or about 0.1 phr to about 1 phr of a second accelerator. The second accelerator can be selected from the group consisting of an amine, an imine, a sulfenamide, a guanidine, a dithiocarbamate, a thiadiazole, a thiazole, a thiourea, a thiuram, a dithiophosphate, a xanthate, and a combination thereof. In a further aspect, the second accelerator can be selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; 1,3-di-o-tolylguanidine; triphenylguanidine; zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N-N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.

In another aspect, the composition can further comprise a filler, a wax, an antidegradant, a fatty acid, a processing oil, a cure activator, a curing agent, or a combination thereof. In another aspect, the composition can comprise from about 0.5 phr to about 150 phr, about 0.5 phr to about 100 phr, about 0.5 phr to about 75 phr, about 0.5 phr to about 50 phr, or about 0.5 phr to about 25 phr of the filler. In another aspect, the composition can comprise from about 1 phr to about 10 phr, about 1 phr to about 5 phr, or about 5 phr to about 10 phr of the antidegradant. In another aspect, the composition can comprise from about 1 phr to about 50 phr, about 1 phr to about 40 phr, about 1 phr to about 30 phr, or about 1 phr to about 20 phr of the processing oil.

In another aspect, waxes can be included in amounts of about 1 phr to about 5 phr. Examples of waxes include microcrystalline waxes, paraffin waxes, and isoparaffin waxes. Fatty acids can be included in amounts of about 0.5 phr to about 3 phr. Examples of fatty acids include, but are not limited to, stearic acid, palmitic acids, oleic acid, and mixtures thereof. Activators can be included in amounts of about 1 phr to about 10 phr or about 1 phr to about 5 phr. Activators can include, but are not limited to, magnesium oxide, zinc oxide, calcium oxide, and polyethylene glycol. Curing or vulcanizing agents can be included in amounts of about 0.1 phr to about 8.0 phr or about 0.1 phr to about 5.0 phr. The curing or vulcanizing agents can include, but are not limited to, elemental sulfur, a sulfur-containing silane, or a combination thereof. In a further aspect, the composition can additionally comprise retarders in amounts of about 1 phr to about 10 phr. Retarders can include, but are not limited to, phthalic anhydrides, phthalimides (e.g., N-(cyclohexylthio) phthalimide), sulfenamide compounds, and acids (e.g., benzoic acid and salicylic acid).

In one aspect, the filler can comprise carbon black. In one aspect, the carbon black can be an n-type carbon black. Examples of N-type carbon black include those with ASTM designations N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991, as specified by ASTM D1765-21, “Standard Classification System for Carbon Blacks Used in Rubber Products.” These carbon blacks can be characterized as having iodine absorptions, as determined according to ASTM D1510-21, ranging from about 9 g/kg to about 145 g/kg. These carbon blacks can also be characterized as having a dibutyl phthalate (DBP) absorption number, as determined according to ASTM D2414, ranging from about 34 cm³/100 g to about 150 cm³/100 g.

Antidegradants can include antioxidants and antiozonants. Representative antioxidants include, but are not limited to, phenylene diamine compounds (e.g., diphenyl-p-phenylenediamine), hydroquinoline compounds (e.g., 2,2,4-trimethyl-1,2-dihydroquinoline), amine compounds, dithiocarbamate compounds, phenolic compounds, phosphite compounds, toluimidazole compounds, and others, such as those disclosed in The Vanderbilt Rubber Handbook (1978), Pages 344 through 346. Representative antiozonants include, but are not limited to, N-phenyl-N′-(1,3-dimethylbutyl)-p-phenylenediamine (6PPD) and N,N′-dixylene-p-phenylenediamine (DTPD).

The processing oil can be included in the composition as an extending oil typically used to extend elastomers. The processing oil can also be included in the elastomer composition by addition of the oil directly during rubber compounding. The processing oil used can include both an extending oil present in the elastomers and a process oil added during compounding. Suitable processing oils include, but are not limited to, various oils as are known in the art, including aromatic, paraffinic, naphthenic, vegetable oils, and low polycyclic aromatics (PCA) oils, such as MES, TDAE, SRAE, and heavy naphthenic oils. In one aspect, the low PCA oils can have a PCA content of less than about 5% or less than about 3% by weight. Suitable vegetable oils include, for example, soybean oil, sunflower oil, and canola oil which are in the form of esters containing a certain degree of unsaturation.

### C. Preparation and Applications of Rubber Compositions

Rubber compositions can be compounded by methods generally known in the rubber compounding art. In one aspect, methods for compounding rubber can include mixing an elastomer, accelerator, and hydrogenated gum rosin together with, optionally, various vulcanizable constituent rubbers and with, optionally, various commonly used additive materials such as: fillers, waxes, antidegradants, fatty acids, processing oils, cure activators, and curing or vulcanizing agents. More specifically, disclosed herein is a method for mixing rubber, comprising: combining together an elastomer and about 0.1 phr to about 10 phr of a hydrogenated gum rosin, thereby forming an initial mixture; mixing the initial mixture at a temperature of about 130° C. to about 180° C., thereby forming a first stage mixture; combining together the first stage mixture with 0.1 phr to about 5 phr of a first accelerator and about 0.1 phr to about 5 phr a second accelerator, thereby forming an intermediate mixture; and mixing the intermediate mixture at a temperature of about 90° C. to about 110° C., thereby forming a second stage mixture. In a further aspect, the initial mixture can be mixed at a temperature of about 130° C. to about 180° C., about 140° C. to about 180° C., about 150° C. to about 180° C., about 130° C. to about 170° C., about 130° C. to about 160° C., or about 140° C. to about 170° C. In another further aspect, the intermediate mixture can be mixed at a temperature of about 90° C. to about 110° C., about 100° C. to about 110° C., or about 90° C. to about 100° C.

In one aspect, the rubber composition may be subjected to a thermomechanical mixing step. The mixing stages can comprise thermomechanical mixing, generally characterized by mechanical working in a mixer (e.g., internal batch mixer) or extruder for a period of time at an elevated temperature suitable to produce a rubber. The appropriate duration of the thermomechanical mixing varies as a function of the operating conditions and the volume and nature of the components. For example, the thermomechanical mixing may be from about 0.5 to 10 minutes.

In another aspect, the elastomer can comprise from about 25 phr to about 75 phr, about 30 phr to about 75 phr, about 35 phr to about 75 phr, about 40 phr to about 75 phr, about 25 phr to about 70 phr, about 25 phr to about 65 phr, about 25 phr to about 60 phr, about 30 phr to about 70 phr, or about 40 phr to about 60 phr of natural rubber. In another aspect, the elastomer can comprise from about 25 phr to about 75 phr, about 30 phr to about 75 phr, about 35 phr to about 75 phr, about 40 phr to about 75 phr, about 25 phr to about 70 phr, about 25 phr to about 65 phr, about 25 phr to about 60 phr, about 30 phr to about 70 phr, or about 40 phr to about 60 phr of a synthetic elastomer. In one aspect, the total phr of natural rubber and synthetic elastomer present in the composition totals to 100 phr. The synthetic elastomer can comprise repeat units formed from residues of monomers selected from ethylene, propylene, isobutene, butadiene, isoprene, styrene, and acrylonitrile, and a combination thereof. In another aspect, the elastomers can have a number average molecular weight (Mₙ) between 100,000 Da and 500,000 Da. Mn may be determined by methods known in the art, such as by gel permeation chromatography following ASTM D3536 or equivalent. In another aspect, the composition can comprise from about 0.1 phr to about 10 phr, about 0.1 phr to about 8 phr, about 0.1 phr to about 5 phr, about 0.1 phr to about 3 phr, about 1 phr to about 10 phr, about 3 phr to about 10 phr, about 5 phr to about 10 phr, or about 7 phr to about 10 phr, about 0.5 phr to about 5 phr, or about 0.5 phr to about 3 phr of a hydrogenated gum rosin. An example of a hydrogenated gum rosin is white or water-white gum rosin, which can be produced from raw gum rosin by processes such as hydrogenation, disproportionation, and other treatment methods. Hydrogenated gum rosin can be characterized by a variety of physical properties, including acid value and softening points. In one aspect, the hydrogenated gum rosin can have an acid value of from about 140 mg KOH/g to about 200 mg KOH/g, about 150 mg KOH/g to about 200 mg KOH/g, about 160 mg KOH/g to about 200 mg KOH/g, about 170 mg KOH/g to about 200 mg KOH/g, about 140 mg KOH/g to about 190 mg KOH/g, about 140 mg KOH/g to about 180 mg KOH/g, about 140 mg KOH/g to about 170 mg KOH/g, about 150 mg KOH/g to about 190 mg KOH/g, or about 160 mg KOH/g to about 180 mg KOH/g. In one aspect, the hydrogenated gum resin can have a softening point of from about 70° C. to about 125° C., about 70° C. to about 115° C., about 70° C. to about 105° C., about 70° C. to about 100° C., about 70° C. to about 90° C., about 80° C. to about 125° C., about 90° C. to about 125° C., about 100° C. to about 125° C., about 80° C. to about 115° C., or about 90° C. to about 105° C.

In another aspect, the accelerator can comprise from about 0.1 phr to about 5 phr, about 0.1 phr to about 4 phr, about 0.1 phr to about 3 phr, or about 0.1 phr to about 2 phr of a first accelerator. The first accelerator can be selected from a dithiocarbamate compound, a thiuram compound, a guanidine compound, and a combination thereof. In a further aspect, the first accelerator can be selected from zinc diethyl dithiocarbamate; zinc N-dibutyl dithiocarbamate; zinc N-ethyl-N-phenyl dithiocarbamate; zinc dibenzyldithiocarbamate; tetrabenzylthiuram disulfide; diphenylguanidine; 1,3-di-o-tolylguanidine; triphenylguanidine; and a combination thereof. In another aspect, the first accelerator can be selected from a thiuram compound, a guanidine compound, and a combination thereof. In a further aspect, the first accelerator can be selected from tetrabenzylthiuram disulfide, diphenylguanidine, 1,3-di-o-tolylguanidine, triphenylguanidine, and a combination thereof. In another further aspect, the first accelerator can be selected from tetrabenzylthiuram disulfide, diphenylguanidine, and a combination thereof.

In another aspect, the accelerator can comprise from about 0.1 phr to about 5 phr, about 0.1 phr to about 4 phr, about 0.1 phr to about 3 phr, or about 0.1 phr to about 2 phr of a second accelerator. The second accelerator can be selected from the group consisting of an amine, an imine, a sulfenamide, a guanidine, a dithiocarbamate, a thiadiazole, a thiazole, a thiourea, a thiuram, a dithiophosphate, a xanthate, and a combination thereof. In a further aspect, the second accelerator can be selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; 1,3-di-o-tolylguanidine; triphenylguanidine; zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N-N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.

In a further aspect, forming the initial mixture can further comprise combining together at least one of a filler, a wax, an antidegradant, a fatty acid, or a processing oil. The filler can be carbon black. In one aspect, the filler can be used in amounts of from about 0.5 phr to about 150 phr, about 0.5 phr to about 100 phr, about 0.5 phr to about 75 phr, about 0.5 phr to about 50 phr, or about 0.5 phr to about 25 phr. In another aspect, the wax can be used in amounts of from about 1 phr to about 5 phr. In another aspect, the antidegradant can be used in amounts of from about 1 phr to about 10 phr, about 1 phr to about 5 phr, or about 5 phr to about 10 phr. In another aspect, the fatty acid can be used in amounts of from about 0.5 phr to about 3 phr. In another aspect, the processing oil can be used in amounts of from about 1 phr to about 50 phr, about 1 phr to about 40 phr, about 1 phr to about 30 phr, or about 1 phr to about 20 phr. Examples of the various additives (e.g., filler, wax, etc.) include those previously listed.

In a further aspect, forming the intermediate mixture further comprises combining together at least one of a retarder, a cure activator, or a curing agent to form the intermediate mixture. In another aspect, the retarder can be used in amounts of from about 1 phr to about 10 phr. In another aspect, the cure activator can be used in amounts of from about 1 phr to about 10 phr or about 1 phr to about 5 phr. In another aspect, the curing agent can be used in amounts of from about 0.1 phr to about 8.0 phr or about 0.1 phr to about 5.0 phr. Examples of the various additives (e.g., retarder, cure activator, etc.) include those previously listed.

### D. Rubber Articles

Also disclosed herein are articles that incorporate any of the compositions disclosed herein and/or are produced by any of the methods disclosed herein. In one aspect, the article comprises a tire, such as a pneumatic tire, or a component of a tire. The tire can be a race tire, passenger tire, aircraft tire, agricultural tire, off-the-road tire, truck or bus tire, and the like. The tire can also be a radial tire or bias tire. The component of the tire can be a tread, base, sidewall, apex, chafer, sidewall insert, wirecoat, innerliner, or any combination thereof. In another aspect, the component of the tire can be a chafer, a sidewall, or any combination thereof. Vulcanization of the disclosed tires is generally carried out at conventional temperatures ranging from, for example, about 100° C. to about 200° C. or from about 110° C. to about 180° C. Such tires can be built, shaped, molded and cured by various methods which are known and will be readily apparent to those having skill in such art.

In one aspect, the articles have good ozone resistance. For example, the articles can exhibit little to no cracking, splitting, and/or other defects after undergoing various methods of ozone testing. In one aspect, the articles can exhibit no cracking after dynamic ozone testing, wherein the dynamic ozone testing is performed following the method detailed in at least one of American Society for Testing and Materials (ASTM) method D1149 or German Institute for Standardization (DIN) method 53509. In another aspect, the articles can exhibit no cracking after static ozone testing, wherein the static ozone testing is performed following the method detailed in at least one of ASTM D1149 or DIN method 53509.

Without wishing to be bound by theory, it is believed that wax that has migrated to the surface of rubber articles (e.g., a tire sidewall or tire chafer) protects the article against ozone damage during static storage. However, wax migration can also cause visible wax blooming on surfaces of the articles, which can be seen as a negative by both users and sellers of the articles. The disclosed articles maintain good ozone resistance while reducing visible wax blooming compared to similar articles that do not contain a gum rosin.

### E. Aspects

The following listing of exemplary aspects supports and is supported by the disclosure provided herein.
Aspect 1. formed from residues of monomers selected from isobutene and isoprene.
Aspect 2. The composition of aspect 1, wherein the elastomer comprises from about 40 phr to about 60 phr of a natural rubber and from about 40 phr to about 60 phr of a synthetic elastomer.
Aspect 3. The composition of aspect 1 or aspect 2, wherein the first accelerator is selected from a dithiocarbamate, a thiuram compound, a guanidine compound, and a combination thereof.
Aspect 4. The composition of any one of aspects 1-3, wherein the first accelerator is selected from zinc diethyl dithiocarbamate; zinc N-dibutyl dithiocarbamate; zinc N-ethyl-N-phenyl dithiocarbamate; zinc dibenzyldithiocarbamate; tetrabenzylthiuram disulfide; diphenylguanidine; 1,3-di-o-tolylguanidine; triphenylguanidine; and a combination thereof.
Aspect 5. The composition of any one of aspects 1-4, wherein the accelerator comprises from about 0.1 phr to about 3 phr of the first accelerator.
Aspect 6. The composition of any one of aspects 1-5, wherein the second accelerator is selected from the group consisting of an amine, an imine, a sulfenamide, a guanidine, a dithiocarbamate, a thiadiazole, a thiazole, a thiourea, a thiuram, a dithiophosphate, a xanthate, and a combination thereof.
Aspect 7. The composition of any one of aspects 1-6, wherein the second accelerator is selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; 1,3-di-o-tolylguanidine; triphenylguanidine; Zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio) benzothiazole; ethylenethiourea; N-N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.
Aspect 8. The composition of any one of aspects 1-7, wherein the accelerator comprises from about 0.1 phr to about 1 phr of the second accelerator.
Aspect 9. The composition of any one of aspects 1-8, wherein the hydrogenated gum rosin has an acid value of about 140 mg KOH/g to about 180 mg KOH/g.
Aspect 10. The composition of any one of aspects 1-9, wherein the hydrogenated gum rosin has a softening point of about 70° C. to about 100° C.
Aspect 11. The composition of any one of aspects 1-10, wherein the hydrogenated gum rosin is present in an amount of about 0.1 phr to about 5 phr.
Aspect 12. The composition of any one of aspects 1-11, wherein the hydrogenated gum rosin is present in an amount of about 0.1 phr to about 3 phr.
Aspect 13. The composition of any one of aspects 1-12, further comprising at least one wax.
Aspect 14. The composition of any one of aspects 1-13, wherein the composition further comprises a filler, a wax, an antidegradant, a fatty acid, a processing oil, zinc oxide, a curing agent, or a combination thereof.
Aspect 15. The composition of any one of aspects 1-14, wherein the composition comprises a filler, the filler comprising carbon black.
Aspect 16. An article comprising the composition of any one of aspects 1-15.
Aspect 17. The article of aspect 16, wherein the article comprises a tire or a component of a tire.
Aspect 18. The article of aspect 16 or aspect 17, wherein the component of the tire comprises a sidewall or a chafer.
Aspect 19. The article of any one of aspects 16-18, wherein the article exhibits visually reduced wax blooming on a surface of the article compared to an equivalent article that does not comprise the hydrogenated gum rosin.
Aspect 20. The article of any one of aspects 16-19, wherein the article exhibits no cracking after dynamic ozone testing, wherein the dynamic ozone testing is performed following the method detailed in at least one of ASTM D1149 or DIN 53509.
Aspect 21. The article of any one of aspects 16-20, wherein the article exhibits no cracking after static ozone testing, wherein the static ozone testing is performed following the method detailed in ASTM D1149 or DIN 53509.
Aspect 22. A method for mixing rubber, comprising: combining together an elastomer and about 0.1 phr to about 10 phr of a hydrogenated gum rosin, thereby forming an initial mixture; mixing the initial mixture at a temperature of about 130° C. to about 180° C., thereby forming a first stage mixture; combining together the first stage mixture with 0.1 phr to about 5 phr of a first accelerator and about 0.1 phr to about 5 phr a second accelerator, thereby forming an intermediate mixture; and mixing the intermediate mixture at a temperature of about 90° C. to about 110° C., thereby forming a second stage mixture; wherein the elastomer comprises from about 25 phr to about 75 phr of a natural rubber and from about 25 phr to about 75 phr of a synthetic elastomer; and wherein the hydrogenated gum rosin has an acid value of about 140 mg KOH/g to about 200 mg KOH/g and a softening point of about 70° C. to about 125° C.
Aspect 23. The method of aspect 22, wherein forming the initial mixture further comprises combining together at least one of a filler, a wax, an antidegradant, a fatty acid, or a processing oil.
Aspect 24. The method of aspect 23, wherein the filler comprises carbon black.
Aspect 25. The method of any one of aspects 22-24, wherein forming the intermediate mixture further comprises combining together at least one of a retarder, a cure activator, or a curing agent to form the intermediate mixture.

From the foregoing, it will be seen that aspects herein are well adapted to attain all the ends and objects hereinabove set forth together with other advantages which are obvious and which are inherent to the structure. While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims. The skilled artisan will recognize many variants and adaptations of the aspects described herein. These variants and adaptations are intended to be included in the teachings of this disclosure and to be encompassed by the claims herein. Now having described the aspects of the present disclosure, in general, the following Examples describe some additional aspects of the present disclosure. While aspects of the present disclosure are described in connection with the following examples and the corresponding text, there is no intent to limit aspects of the present disclosure to this description. On the contrary, the intent is to cover all alternatives, modifications, and equivalents included within the spirit and scope of the present disclosure.

### F. Examples

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Evaluation of Rubber Compositions

Seven rubber compositions comprising a polybutadiene rubber and natural rubber-based matrix are provided in Table 1. Notable differences between the compositions include the presence of a gum rosin and the type of accelerators used.

TABLE 1
Rubber composition with amounts shown in phr.

| | | Experimental | | | | | |
|---|---|---|---|---|---|---|---|
| Ingredient | Control | A | B | C | D | E | F |
| polybutadiene | 50 | 50 | 50 | 50 | 50 | 50 | 50 |
| rubber | | | | | | | |
| natural rubber¹ | 50 | 50 | 50 | 50 | 50 | 50 | 50 |
| carbon black² | 25 | 25 | 25 | 25 | 25 | 25 | 25 |
| carbon black³ | 15 | 15 | 15 | 15 | 15 | 15 | 15 |
| resin⁴ | — | — | — | — | — | 3 | — |
| gum rosin | — | 1 | 1 | 0.5 | 1.5 | 1 | 1 |
| isoparaffin wax | 2 | 2 | 2 | 2 | 2 | 2 | 2 |
| antidegradant⁵ | 0.5 | 0.5 | 0.5 | 0.5 | 0.5 | 0.5 | 0.5 |
| antidegradant ⁶ | 1 | 1 | 1 | 1 | 1 | 1 | 1 |
| paraffin wax | 0.2 | 0.2 | 0.3 | 0.3 | 0.3 | 0.3 | 0.3 |
| antidegradant⁷ | 4.75 | 4.75 | 4.25 | 4.25 | 4.25 | 4.25 | 4.25 |
| processing oil⁸ | 13 | 13 | 13 | 13 | 13 | 13 | 13 |
| stearic acid | 1 | 1 | 1 | 1 | 1 | 1 | 1 |
| NP1⁹ Total | 162.45 | 163.45 | 163.05 | 162.55 | 163.55 | 166.05 | 163.05 |
| accelerator¹⁰ | — | — | — | — | — | — | 1 |
| zinc oxide | 3.5 | 3.5 | 3.5 | 3.5 | 3.5 | 3.5 | 3.5 |
| insoluble sulfur | 2.84 | 2.84 | 2.84 | 2.84 | 2.84 | 2.84 | 1.4 |
| accelerator¹¹ | 0.7 | 0.7 | 0.7 | 0.7 | 0.7 | 0.7 | 0.35 |
| accelerator¹² | — | 0.3 | 0.3 | 0.15 | 0.5 | 0.3 | 0.3 |
| Total phr | 169.49 | 170.79 | 170.39 | 169.74 | 171.09 | 173.39 | 169.6 |
| Specific Gravity | 1.075 | 1.075 | 1.075 | 1.075 | 1.075 | 1.075 | 1.073 |

¹TSR grade
²N550
³N220
⁴phenol formaldehyde
⁵mixed aryl-p-phenylenediamines
⁶ 2,2,4-trimethyl-1,2-dihydroquinoline
⁷N-phenyl-N′-(1,3-dimethylbutyl)-p-phenylenediamine
⁸treated distillate aromatic extract oil with low polycyclic aromatic content
⁹nonproductive mixture 1
¹⁰tetrabenzylthiuram disulfide
¹¹N-cyclohexyl benzothiazol-2-sulfenamide
¹²diphenylguanidine

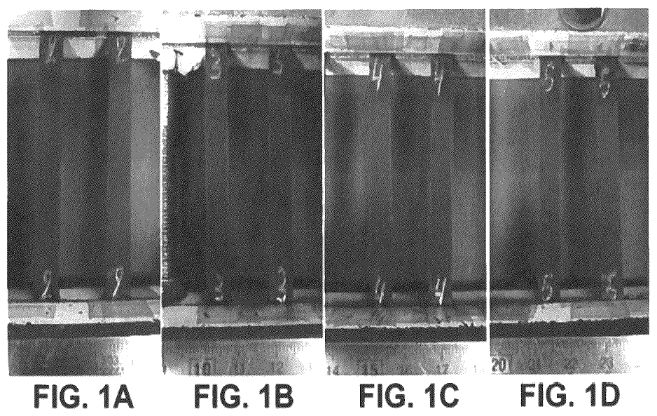

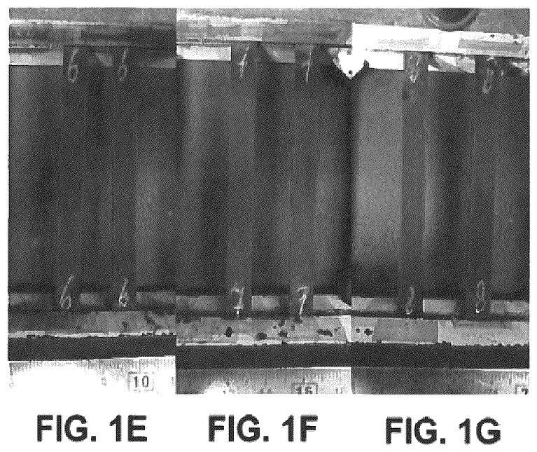

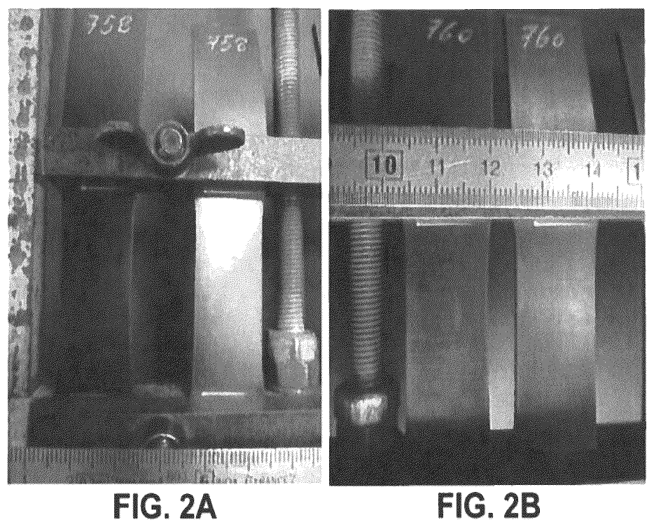

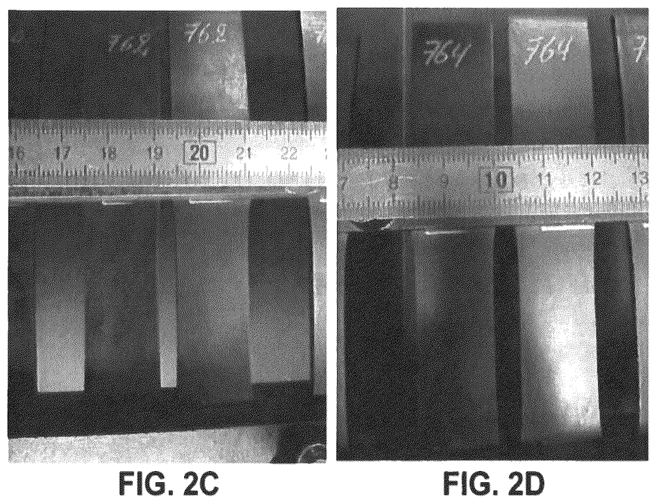

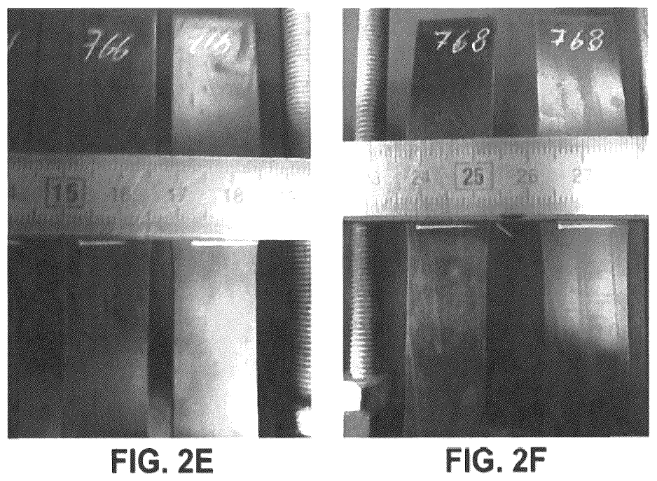

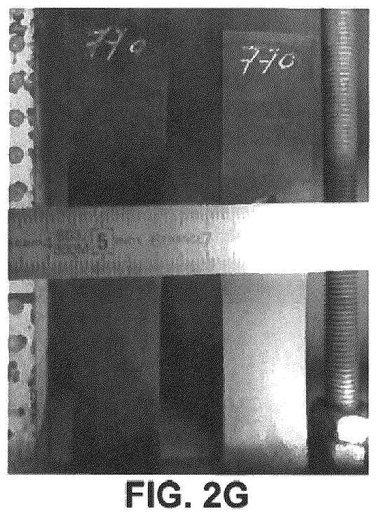

Dynamic and static ozone resistance tests were performed on sidewall rubber specimens formed from the compositions listed in Table 1. FIGS. 1A-1G show pictures of sidewall rubber specimens after undergoing dynamic ozone resistance testing in accordance with testing methods such as ASTM D1149 and DIN 53509. The sidewall rubber specimen of FIG. 1A corresponds to the Control composition, while the sidewall rubber specimens of FIGS. 1B-1G correspond to the Experimental compositions, specifically Expermintal A (FIG. 1B), Expermintal B (FIG. 1C), Expermintal C (FIG. 1D), Expermintal D (FIG. 1E), Expermintal E (FIG. 1F), and Expermintal F (FIG. 1G). FIGS. 2A-2G show pictures of sidewall rubber specimens after undergoing static ozone resistance testing in accordance with testing methods such as ASTM D1149 and DIN 53509. The sidewall rubber specimen of FIG. 2A corresponds to the Control composition, while the sidewall rubber specimens of FIGS. 2B-2G correspond to the Experimental compositions, specifically Expermintal A (FIG. 2B), Expermintal B (FIG. 2C), Expermintal C (FIG. 2D), Expermintal D (FIG. 2E), Expermintal E (FIG. 2F), and Expermintal F (FIG. 2G). For both dynamic and static ozone testing, the rubber specimens had an ozone resistance rating of Grade 0, meaning no cracks, splits, or other defects were observed on the rubber specimens. This indicates that all of the rubber specimens had good ozone resistance.

Briefly, the dynamic ozone testing and static ozone testing was performed in accordance with either ASTM D1149, DIN 53509, or a combination thereof. Rubber specimens are prepared from vulcanized rubber compositions. The rubber specimens tested were rectangular strips with dimensions of 65 mm×10 mm×2 mm for the dynamic ozone testing and 254 mm×150 mm×2 mm for the static ozone testing. The specimens are exposed to a known, controlled concentration of ozone in a chamber for 12 hours (dynamic ozone testing) or 24 hours (static ozone testing) at a temperature of 38° C. In this Example, the ozone concentration was 50 pphm. For dynamic ozone testing, the samples were tested under these conditions at a relative humidity of 60% while applying a dynamic maximum amplitude tensile strain of 0% to 25% elongation at a fixed frequency of 0.5 Hz. For static ozone testing, the samples were tested under these conditions at a relative humidity of 40% while applying a constant tensile strain of 20% elongation.

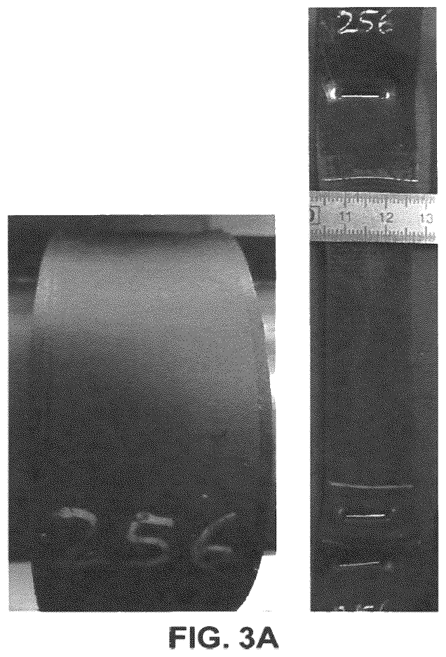

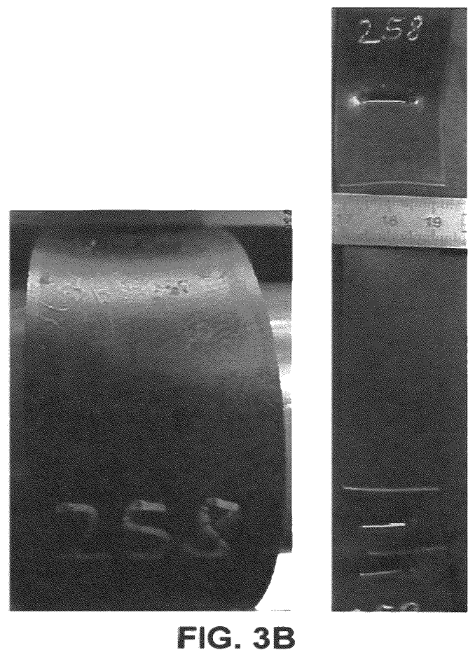

FIGS. 3A-3B show pictures of sidewall rubber specimens that have undergone flex static ozone resistance testing, where the specimen of FIG. 3A does not contain a gum rosin or diphenylguanidine and the specimen of FIG. 3B contains both a gum rosin or diphenylguanidine. The sidewall rubber specimen of FIG. 3A corresponds to the Control composition and the sidewall rubber specimen of FIG. 3B corresponds to composition Experimental A. Both rubber specimens show no stress marks following flex static ozone testing. However, the specimen that included gum rosin and diphenylguanidine shows significantly less visible wax blooming than the other specimen. Without wishing to be bound by theory, it is believed that wax migrating at the surface of a tire sidewall and/or chafer protects the tire against ozone during static storage. However, this wax migration or excess wax migration can also result in visible wax blooming on the surface of the tire, which can be seen as a negative by both those who sell and purchase tires. These compositions maintain ozone resistance while reducing visible wax blooming.

Briefly, for the flex static ozone testing, rubber specimens are prepared from vulcanized rubber compositions. The rubber specimens tested were rectangular strips with dimensions of 150 mm×20 mm×6 mm. The specimens are exposed to a known, controlled concentration of ozone (200 pphm) in a chamber for 46 hours at a temperature of 25° C. and a relative humidity of 60%. In this Example, the ozone concentration was 50 pphm. The samples were tested under these conditions while applying a continuous tensile strain of 7% elongation.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A composition, comprising:
an elastomer, comprising from about 25 phr to about 75 phr of a natural rubber and from about 25 phr to about 75 phr of a synthetic elastomer;
an accelerator, comprising from about 0.1 phr to about 5 phr of a first accelerator and about 0.1 phr to about 5 phr a second accelerator; and
about 0.1 phr to about 10 phr of a hydrogenated gum rosin;
wherein the hydrogenated gum rosin has an acid value of about 140 mg KOH/g to about 200 mg KOH/g and a softening point of about 70° C. to about 125° C.

2. The composition of claim 1, wherein the synthetic elastomer comprises repeat units formed from residues of monomers selected from ethylene, propylene, isobutene, butadiene, isoprene, styrene, acrylonitrile, and a combination thereof.

3. The composition of claim 1, wherein the first accelerator is selected from a dithiocarbamate, a thiuram compound, a guanidine compound, and a combination thereof.

4. The composition of claim 1, wherein the first accelerator is selected from zinc diethyl dithiocarbamate; zinc N-dibutyl dithiocarbamate; zinc N-ethyl-N-phenyl dithiocarbamate; zinc dibenzyldithiocarbamate; tetrabenzylthiuram disulfide; diphenylguanidine; 1,3-di-o-tolylguanidine; triphenylguanidine; and a combination thereof.

5. The composition of claim 1, wherein the second accelerator is selected from the group consisting of an amine, an imine, a sulfenamide, a guanidine, a dithiocarbamate, a thiadiazole, a thiazole, a thiourea, a thiuram, a dithiophosphate, a xanthate, and a combination thereof.

6. The composition of claim 1, wherein the second accelerator is selected from the group consisting of cyclohexylethylamine; hexamethylene tetramine; ethyldiene aniline; butyraldehyde dianiline condensate; N-cyclohexyl-2-benzothiazolesulfenamide; N-tertbutyl-2-benzothiazolesulfenamide; N,N-dicyclohexyl-2-benzothiazolesulfenamide; 2-(2-4′dinitrophenylmercapto) benzothiazole; 1,3-di-o-tolylguanidine; triphenylguanidine; Zinc diethyl dithiocarbamate; zinc N-dibutyl dithiocarbamate; zinc N-ethyl-N-phenyl dithiocarbamate; zinc dibenzyldithiocarbamate; N-cyclohexyl-S-(1,3,4-thiadiazol-2-yl)thiohydroxylamine; 2-mercaptobenzothiazole; 2,2′-dithiobenzothiazole; zinc 2-mercaptobenzothiazole; 2-(morpholinothio)benzothiazole; ethylenethiourea; N-N′-diphenylthiourea; tetramethylthiuram disulfide; tetraethylthiuram disulfide; tetramethylthiuram monosulfide; dipentamethylenethiuram tetrasulfide; zinc dithiophosphate; zinc butylxanthate; sodium isopropyl xanthate; and a combination thereof.

7. The composition of claim 1, wherein the hydrogenated gum rosin has an acid value of about 140 mg KOH/g to about 180 mg KOH/g.

8. The composition of claim 1, wherein the hydrogenated gum rosin has a softening point of about 70° C. to about 100° C.

9. The composition of claim 1, wherein the composition further comprises a filler, a wax, an antidegradant, a fatty acid, a processing oil, zinc oxide, a curing agent, or a combination thereof.

10. The composition of claim 9, wherein the composition comprises a filler, the filler comprising carbon black.

11. An article comprising the composition of claim 1.

12. The article of claim 11, wherein the article comprises a tire or a component of a tire.

13. The article of claim 12, wherein the component of the tire comprises a sidewall or a chafer.

14. The article of claim 11, wherein the article exhibits visually reduced wax blooming on a surface of the article compared to an equivalent article that does not comprise the hydrogenated gum rosin.

15. The article of claim 11, wherein the article exhibits no cracking after dynamic ozone testing, wherein the dynamic ozone testing is performed following the method detailed in at least one of ASTM D1149 or DIN 53509.

16. The article of claim 11, wherein the article exhibits no cracking after static ozone testing, wherein the static ozone testing is performed following the method detailed in ASTM D1149 or DIN 53509.

17. A method for mixing rubber, comprising:
combining together an elastomer and about 0.1 phr to about 10 phr of a hydrogenated gum rosin, thereby forming an initial mixture;
mixing the initial mixture at a temperature of about 130° C. to about 180° C., thereby forming a first stage mixture;
combining together the first stage mixture with 0.1 phr to about 5 phr of a first accelerator and about 0.1 phr to about 5 phr a second accelerator, thereby forming an intermediate mixture; and
mixing the intermediate mixture at a temperature of about 90° C. to about 110° C., thereby forming a second stage mixture;
wherein the elastomer comprises from about 25 phr to about 75 phr of a natural rubber and from about 25 phr to about 75 phr of a synthetic elastomer; and
wherein the hydrogenated gum rosin has an acid value of about 140 mg KOH/g to about 200 mg KOH/g and a softening point of about 70° C. to about 125° C.

18. The method of claim 17, wherein forming the initial mixture further comprises combining together at least one of a filler, a wax, an antidegradant, a fatty acid, or a processing oil.

19. The method of claim 18, wherein the filler comprises carbon black.

20. The method of claim 17, wherein forming the intermediate mixture further comprises combining together at least one of a retarder, a cure activator, or a curing agent to form the intermediate mixture.
